(19) United States
(12) Patent Application Publication
(10) Pub. No.: US 2010/0013597 A1
(43) Pub. Date: Jan. 21, 2010

(54) Biometric medication container

(75) Inventors: Gary E. Determan, Maple Grove, MN (US); Thomas A. Plocher, Hugo, MN (US); Rand P. Whillock, North Oaks, MN (US); Yong Ming Kow, Whitehouse (SG); Liana M. Kiff, Minnetonka, MN (US); George A. Kilgore, Colorado Springs, CO (US)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: Honeywell International, Inc.

(21) Appl. No.: 11/180,490

(22) Filed: Jul. 13, 2005

(51) Int. Cl. G05B 19/00

(52) U.S. Cl. 340/5.82

(57) ABSTRACT

A locked medication container can be unlocked opened in response to a person's matching biometric characteristic and satisfaction of pre-established rules of access relating to day and time. One type of characteristic is a finger or thumb print. A communication can be sent to a remote site indicating that access was attempted by a specific person at a specific date and time and was successful or unsuccessful.

### FIELD

The invention pertains to containers that are accessible in response to a matching biometric characteristic. More particularly, the invention pertains to medication containers that respond to one or more pre-established thumbprints or fingerprints.

### BACKGROUND

Various biometric characteristics can be used to identify individuals. These include voice prints, thumb or finger prints, retinal scans, facial images and the like. Known products that reply on biometric inputs to open or contain appear merely to respond to a biometric input.

Medication containers, or caddies have been used to assist individuals in storing medications and in maintaining a medication schedule.

There is a need to provide security in connection with access to and dispersing of medications or pharmaceutical products. There are also circumstances where it is desirable to know who and when an individual has had access to medication or pharmaceutical products. In addition to securing such products from children in a residence, there are circumstances where adults such as repair people or other service providers come into the residence, perhaps unsupervised, for periods of time.

There are also instances where a medicine caddy may need to have a schedule and a notification device to notify the user that it is time to take her medicine. These automated reminder systems need to know if the correct person has taken a scheduled medication. Given that a person has taken some medication, the system might prevent him/her from entering the caddy again until it is time for the next dose by keeping the lock secure. Preferably the medicine caddy will be secure, programmable and linked to a communication device that allows someone outside of the home to have access to the information stored in the medication caddy.

There is thus a continuing need to provide on-going security for medicinal containers as well as to be able to create and maintain a record of when such containers have been accessed. Preferably indicators can be provided not only as to when such containers have been accessed, but also identify the accessor(s).

It would also be desirable to be able to transmit access information to a remote location. Preferably such transmissions could be effected without having to substantially increase the cost and flexibility of such containers.

### BRIEF DESCRIPTION OF THE DRAWING

FIG. 1 is block diagram of a device in accordance with the invention;

FIG. 2 is a diagram which illustrates additional details of the device of FIG. 1;

FIG. 2 illustrates details of a fingerprint sensor usable with the device of FIG. 1;

FIG. 3 is a diagram which illustrates the device of FIG. 1 in an opened state; and

FIG. 4 is a block diagram of a method in accordance with the invention.

### DETAILED DESCRIPTION

While embodiments of this invention can take many different forms, specific embodiments thereof are shown in the drawings and will be described herein in detail with the understanding that the present disclosure is to be considered as an exemplification of the principles of the invention, as well as the best mode of practicing same, and is not intended to limit the invention to the specific embodiment illustrated.

In accordance with the invention, a medication storage box container has a biometric sensor integrated into it, along with a programmed processor and an Internet interface. In one embodiment of the invention, the biometric sensor can correspond to a finger print or thumb print sensor. This results in a very secure yet easy to unlock container. One of the advantages of the embodiments of the present invention is that the users do not have to worry about having a key or remembering a combination.

The container can be programmed to communicate with one or more displaced locations via a network. Representative networks include without limitation wired or wireless telephone or computer networks such as the Internet. It will be understood that the particular form of network(s) is/are not a limitation of the invention.

Other types of biometrics can be used without departing from the spirit and scope of the invention. These could include voice prints, retinal scans, facial scans, all without limitation.

In one aspect of the invention, a lockable container carries a finger print sensor and then an associated controller. The controller can communicate via the Internet to one or more displaced locations to provide indicia as to time of access of person accessing the container. The controller can incorporate a programmable processor and associated software, responsive to the sensor to identify the individual desiring to access the container. The controller can then determine if the identified person is entitled to access to the medications at a particular time, and/or a particular day in accordance with pre-stored rules. The controller can then provide access to the respective individual by deactivating the lock so that the container can be opened.

A plurality of acceptable, fingerprints can be pre-stored in the system. Additionally, the rules of operation can be pre-stored based on the needs of a respective resident or user. The rules can be programmed locally or can be downloaded to the controller over the Internet using a network communication interface.

The controller can process the sensed thumbprint or fingerprint in a variety of ways as would be understood by those skilled in the art. In one instance, the controller can compare the sensed fingerprint with a plurality of pre-stored templates which are associated with authorized users of the container. Once a match has occurred, if the rules of operation are satisfied, the controller can send a signal to the locking mechanism to release the container. The rules of operation include whether or not the respective individual seeking access is authorized for access at that particular time and date.

In one aspect of the invention, a local user interface located on the container can be implemented with a single visual indicator along with an audio output. The indicator can be energized and the audio output can generate a tone once the user has successfully been identified and the requirements of the rule set have been met.

Another user interface can be provided for the system administrator to enter acceptable fingerprints and to input the rules of operation. Such an interface can be implemented by a program being executed by a computer physically coupled to the container by a universal serial buss, or in communication with the container by a computer network such as the Internet. The second user interface can be used not only to enter fingerprint templates identifying authorized users of the container, but also to enter a modified pre-stored rules of operation.

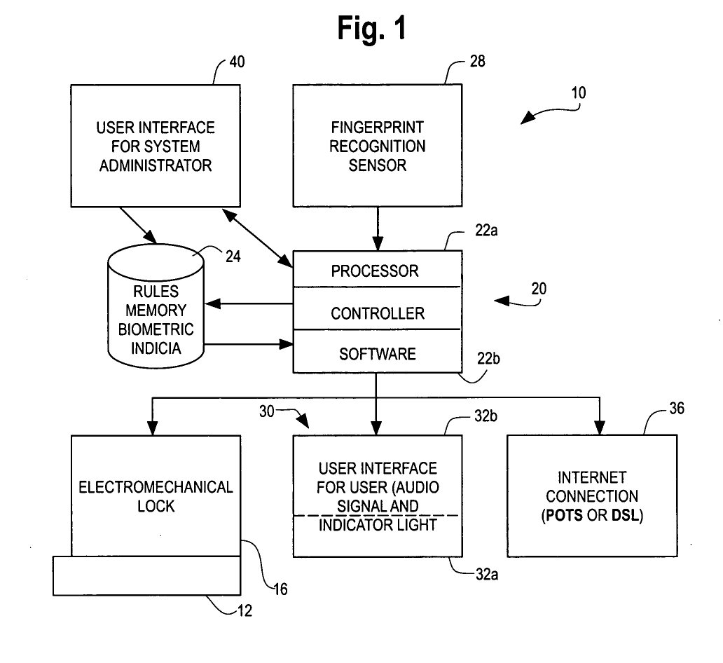

FIG. 1 illustrates an apparatus 10 which embodies the present invention. The apparatus 10 incorporates a container 12 which carries an electromechanical lock 16. The container 12 exhibits a normally locked condition unless until the lock 16 is activated.

The container 12 can also carry a controller 20 which, in addition to control circuitry, can incorporate a programmable processor 22a and software 22b. The controller 20 communicates by bi-directionally with a magnetic or optical memory 24. The memory 24 can incorporate indicia relating to a plurality of acceptable biometric parameters along with a set of operating rules.

In connection with the apparatus 10, a biometric sensor such as thumbprint or a fingerprint responsive sensor 28 can provide biometric information as to an individual seeking to access the container 12. The container 12 can also carry a local user interface indicated generally at 30 which can incorporate a visual indicator 32a as well as an audio output indicator 32b.

If desired, the device 10 can also incorporate an input/output port 36 which can be used for communications (dial-up on high speed access) via a computer network, such as the Internet to one or more remote locations. A second user interface 40 can be provided for a system administrator.

The system administrator can enter a plurality of predetermined biometric indicia, such as for example a plurality of fingerprint identifying indicia as well as a plurality of operating rules. The indicia and operating rules can be pre-stored in memory 24.

User interface 40 can be directly coupled to the device 10. Alternately, it can communicate via the input/output port 36 and the Internet with the device 10 from a displaced location.

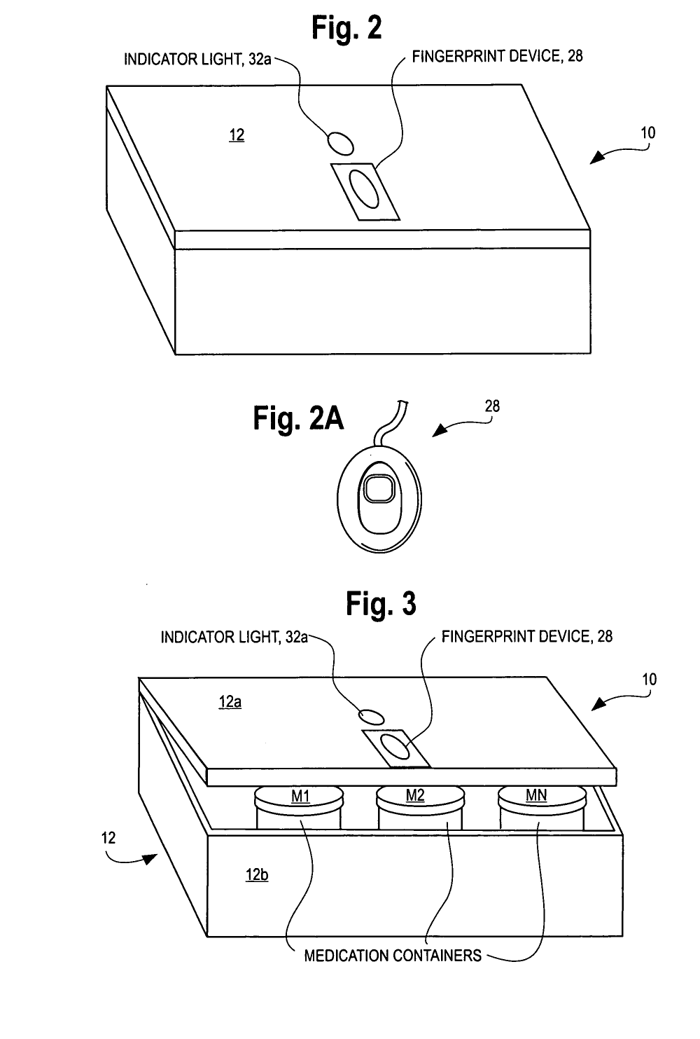

FIG. 2 illustrates the device 10 in a closed state with an indicator light 32a and fingerprint or thumbprint sensor 28. FIG. 2A illustrates additional details of an exemplary fingerprint sensor 28. It will be understood that the exact details of a particular fingerprint sensor are not limitations of the present invention. Other types of biometric sensors could be used.

FIG. 3 illustrates the device 10 in an opened state where a cover 12A has been released from a base 12B such that an authorized user can access one or more medication containers M, M2 . . . Mm. When finished the user can re-close the container 12 at which time the lock 16 remains in a closed state until another acceptable biometric sample, such as a fingerprint, has been sensed and where requirements of the pre-stored operating rules are satisfied.

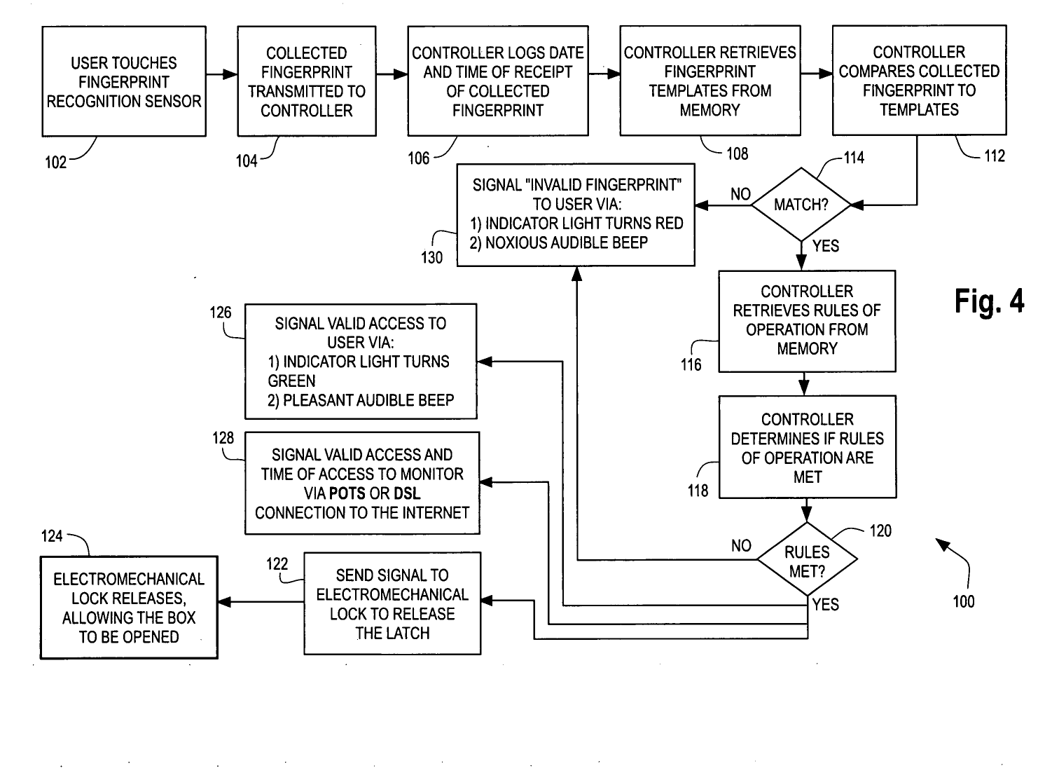

FIG. 4 illustrates steps of a method 100 in accordance with the invention. In a step 102 a user engages the sensor 28 with an appropriate finger. Parameters of the sensed finger are transmitted to a controller 20 in a step 104.

In a step 106, the controller 20 logs in the day and time of receipt of the received fingerprint indicia. Controller 20, in one form of biometric processing, retrieves a plurality of fingerprint template indicia from memory 24 in a step 108.

The fingerprint indicia received in step 104 are compared to pre-stored biometric templates in a step 112. Where a match exists, step 114, the controller 20 would then retrieve one or more pre-stored rules of operation from storage memory unit 24 in a step 116. The controller 20 in a step 118 determines if the respective individual, whose fingerprint has been sensed, is authorized under the pre-stored rules to access the container 12 at this time. Where requirements of the rules have been satisfied, step 120, the lock 16 is activated, step 122 to release or open the box 12, step 124. The user can then access the container 12 and retrieve one or more medications therefrom.

Where there is no match, or the requirements or the rules have not met, in a step 130, the indicator 32a can be energized to emit a red light and the audio output device 32b can be energized to emit a nocuous audible beep. Where the requirements of the rules have been complied with, step 120 in addition to releasing the latch, step 122, the indicator 32a can be energized to emit an acceptance color, such as green. Additionally, the audible output device 32b can be activated to emit a pleasant audible beep.

In addition to the above local activities and indicators, in step 128 communications can be forwarded via a wired or wireless network such as the public switched telephone system and/or a computer based network for providing information to a remote location. The remote location, also accessible via the network, receives the information which for example identifies the individual who has successfully obtained access to the container 12, as well as day and time for profile generation and for follow-up purposes.

The above-described container can alternately be implemented in the form of a cap or a cover for a pill bottle or container. In this embodiment, processor and software 22a,b sensor 28, latch 16, which could also function as a child-proof latch, and a battery can be incorporated into the cap.

During normal operation, the device would recognize a fingerprint of the owner of the bottle, and would then disable the latch, or child-proof mechanism. As a result, minimal effort would be required to open the container.

The device can be configured with minimal memory and processing capabilities if there is only one fingerprint to recognize. This device can work in isolation, or can be designed to record accesses and transmit that information to another devices or systems.

In yet another embodiment, additional circuitry can be provided to sense and indicate access to a specific medication. Systems can also be incorporated as in U.S. patent application Ser. No. 10/741,998, filed Dec. 19, 2003, entitled System and Method for Monitored Delivery of Products, assigned to the assignee hereof and incorporated herein by reference.

From the foregoing, it will be observed that numerous variations and modifications may be effected without departing from the spirit and scope of the invention. It is to be understood that no limitation with respect to the specific apparatus illustrated herein is intended or should be inferred. It is, of course, intended to cover by the appended claims all such modifications as fall within the scope of the claims.

1. A system comprising:
a covered first container of a person which defines an interior region, and, carries a plurality of different medication containers in the region;
a biometric sensor carried by the first container;
control circuitry coupled to the sensor;
a plurality of pre-stored biometric templates associated with respective authorized users of the container;
a plurality of pre-stored operating rules;
a latch coupled to the first container and to the control circuitry, the latch having a first state where the cover of the first container is unopenable and a second state where the cover of the first container is openable, the control circuitry is responsive to select biometric indicia from the sensor where the control circuitry matches the biometric indicia from the sensor with one of the plurality of pre-stored biometric templates, retrieves one or more of the plurality of pre-stored operating rules and determines that a user of the authorized users of the container is authorized at a particular time and a particular day in accordance with the plurality of operating rules and causes the latch to enter the second state where the cover of the first container is openable, and where all medication containers in the region are simultaneously and equally accessible when the cover is opened.

2. A system as in claim 1 where the control circuitry includes software for carrying out a biometric matching function.

3. A system as in claim 1 which includes a database of acceptable biometric indicia.

4. A system as in claim 3 which includes software that compares biometric indicia from the sensor to contents of the data base.

5. A system as in claim 4 which includes a plurality of predetermined rules determinative of when the selected biometric indicia can cause the latch to enter the second state.

6. A system as in claim 5 which includes a user interface for entering acceptable biometric indicia.

7. A system as in claim 6 which includes software for establishing members of the plurality of rules.

8. A system as in claim 7 which includes further software for modifying rules.

9. A system as in claim 5 where at least some of the rules define temporal restrictions.

10. A system as in claim 5 where at least some of the rules relate biometric indicia to at least one of day of the week, or time of day.

11. A system as in claim 1 which includes an access port for communications with a displaced location.

12. A system as in claim 1 which includes software to initiate communications, via a computer network, with a displaced location.

13. A system as claim 12 where the software communicates at least one of day, or time information relative to the latch entering the second state.

14. A system as in claim 13 where the biometric sensor is selected from a class which includes at least fingerprint sensors, palm sensors, voice input transducers, retinal scanners, or visual scanners.

15. A system as in claim 1 which includes a storage unit coupled to the control circuitry.

16. A system as in claim 3 which includes a software to maintain the database on a storage unit coupled to the control circuitry.

17. A system as in claim 16 which includes additional software to maintain a profile of, at least, successful accesses.

18. A system as in claim 17 where the profile includes at least one of time or date information.

19. A system as in claim 6 which includes at least one of a visual or an audible element for indicating whether access is being permitted or denied.

20-27. (canceled)
